(19) United States
(12) Patent Application Publication
(10) Pub. No.: US 2016/0105940 A1
(43) Pub. Date: Apr. 14, 2016

(54) LIGHT EMITTING APPARATUS

(71) Applicant: SAMSUNG ELECTRONICS CO., LTD., Suwon-si (KR)

(72) Inventor: Joon Sub LEE, Seoul (KR)

(21) Appl. No.: 14/754,581

(22) Filed: Jun. 29, 2015

(30) Foreign Application Priority Data
Oct. 14, 2014 (KR) 10-2014-0138254

(51) Int. Cl. H05B 33/08; F21V 23/04; F21K 99/00

(52) U.S. Cl. CPC H05B 33/0869; F21K 9/56; F21V 23/0457

(57) ABSTRACT

A light emitting apparatus includes a light emitting unit including a monochromatic light source configured to emit light having a predetermined color, and a wavelength conversion element configured to generate white light from the light emitted by the monochromatic light source, a spectrum detection unit configured to detect a first spectrum distribution from the light emitted by the monochromatic light source, and detect a second spectrum distribution from the white light, and a controller configured to compare the first spectrum distribution and the second spectrum distribution with a first reference spectrum distribution and a second reference spectrum distribution, respectively, and adjust at least one of a wavelength and an intensity of the light emitted by the monochromatic light source.

### CROSS-REFERENCE TO RELATED APPLICATION

This application claims the priority and benefit of Korean Patent Application No. 10-2014-0138254 filed on Oct. 14, 2014, with the Korean Intellectual Property Office, the disclosure of which is incorporated herein by reference.

### BACKGROUND

The present inventive concept relates to a light emitting device.

Research into light emitting devices using light emitting diodes (LEDs) is being conducted in earnest in order to replace conventional fluorescent lamps having relatively short lifespans and high power consumption. Such light emitting devices include LEDs using nitride semiconductors, or the like, or laser light sources, and the range of applications thereof is gradually being increased due to the inherent advantages thereof, such as relatively low power consumption and relatively long lifespans.

In order to replace conventional fluorescent lamps, various types of light emitting devices emitting white light have been proposed. Although a scheme of generating white light by providing an LED device as a light source to be combined with a predetermined type of phosphor has been proposed, as a temperature of the light source is increased, a wavelength of light emitted by the light source and a wavelength of light generated by the phosphor may change, and thus, white light having desired characteristics may be relatively difficult to obtain. In addition, despite another proposed scheme of providing a light receiving device to detect characteristics of white light including a spectrum distribution in real time to thereby control operations of a light emitting apparatus, an issue in which reflecting a detection error of the light receiving device is problematic may be present therein.

### SUMMARY

An aspect of the present disclosure may provide a light emitting apparatus capable of outputting white light having desired characteristics in a stable manner, irrespective of a temperature change and operation conditions of a light source.

According to an aspect of the present disclosure, alight emitting apparatus may include a light emitting unit including a monochromatic light source configured to emit light having a predetermined color, and a wavelength converting unit configured to generate white light from the light emitted by the monochromatic light source, a spectrum detection unit configured to detect a first spectrum distribution from the light emitted by the monochromatic light source, and detect a second spectrum distribution from the white light, and a controller configured to compare the first spectrum distribution and the second spectrum distribution with a first reference spectrum distribution and a second reference spectrum distribution, respectively, and adjust at least one of a wavelength and an intensity of the light emitted by the monochromatic light source.

The controller may adjust a wavelength of the light emitted by the monochromatic light source by increasing or decreasing a dominant wavelength of the light emitted by the monochromatic light source.

The controller may increase or decrease an intensity of the light emitted by the monochromatic light source based on a result of comparing the second spectrum distribution with the second reference spectrum distribution.

The wavelength converting unit may include a phosphor absorbing a portion of the light emitted by the monochromatic light source and generating light having a different color from the light emitted by the monochromatic light source.

The controller may calculate an intensity ratio of light in a first wavelength band corresponding to a dominant wavelength of the light emitted by the monochromatic light source to light in a second wavelength band corresponding to a dominant wavelength of light generated by the phosphor from each of the second spectrum distribution and the second reference spectrum distribution.

The controller may adjust an intensity of the light emitted by the monochromatic light source based on a result of comparing the intensity ratio calculated from the second spectrum distribution with the intensity ratio calculated from the second reference spectrum distribution.

Conversion efficiency of the phosphor may be determined based on at least one of a dominant wavelength, a full width at half maximum (FWHM), and an intensity of the light emitted by the monochromatic light source.

The wavelength converting unit may be disposed to be separate from the monochromatic light source.

The light emitting unit may further include an optical attenuator and an optical splitter disposed on a path by which the light emitted by the monochromatic light source is transferred to the wavelength converting unit.

The controller may control an operation of the optical attenuator based on a result of comparing the second spectrum distribution with the second reference spectrum distribution.

The spectrum detection unit may include a first spectrum detection unit receiving the light emitted by the monochromatic light source through the optical splitter and detecting a first spectrum distribution, and a second spectrum detector receiving the white light generated by the wavelength conversion element and detecting the second spectrum distribution.

The monochromatic light source may include at least one laser light source capable of adjusting a wavelength of light to be output.

The monochromatic light source may include a plurality of light emitting diode (LED) devices, emitting light having different dominant wavelengths.

The controller may determine an LED device from among the plurality of LED devices to be turned on, based on a result of comparing the first spectrum distribution with the first reference spectrum distribution.

According to another aspect of the present disclosure, a light emitting apparatus may include a monochromatic light source configured to emit light having a predetermined dominant wavelength, a wavelength converting unit including a phosphor having light conversion efficiency determined by characteristics of the light emitted by the monochromatic light source, and configured to generate white light from the light emitted by the monochromatic light source, a spectrum detection unit configured to detect spectrum distributions of the white light emitted by the wavelength converting unit, and a controller configured to compare the detected spectrum distribution with a predetermined reference spectrum distribution and adjust an operation of the monochromatic light source, wherein when an intensity in a wavelength band emitted by the monochromatic light source in the detected spectrum distribution is the same as an intensity in a wavelength band emitted by the monochromatic light source in the reference spectrum distribution, the controller compares an intensity in a wavelength band converted by the phosphor in the detected spectrum distribution with an intensity in a wavelength band converted by the phosphor in the reference spectrum distribution, and determines a presence of an error in the spectrum detection unit.

According to still another aspect of the present disclosure, a light emitting apparatus may include a light emitting unit including a monochromatic light source emitting light having a predetermined color, a wavelength conversion element converting the light emitted by the monochromatic light source to light having a different color from the predetermined color, a first spectrum detector receiving the light emitted by the monochromatic light source through an optical splitter interposed on a path by which the light emitted by the monochromatic light source is transferred to the wavelength conversion element, and detecting a first spectrum distribution; and a controller configured to adjust a wavelength of the light emitted by the monochromatic light source, based on a result of comparing the first spectrum distribution with a first reference spectrum distribution.

The controller may adjust the wavelength of light emitted by the monochromatic light source by increasing or decreasing a dominant wavelength of the light emitted by the monochromatic light source.

The light emitting apparatus may further include a second spectrum detector receiving the converted light and detecting a second spectrum distribution from the converted light. The controller may adjust an intensity of light emitted by the monochromatic light source and incident onto the wavelength conversion element, based on a result of comparing the second spectrum distribution with a second reference spectrum distribution.

The converted light may be white light.

The wavelength conversion element and the monochromatic light source may not be in direct contact with one another.

### BRIEF DESCRIPTION OF DRAWINGS

The above and other aspects, features and advantages of the present disclosure will be more clearly understood from the following detailed description taken in conjunction with the accompanying drawings, in which:

FIGS. 1 and 2 are block diagrams illustrating light emitting apparatuses according to exemplary embodiments in the present inventive concept;

FIGS. 3 and 4 are views illustrating monochromatic light sources applicable to a light emitting apparatus according to an exemplary embodiment in the present inventive concept;

FIGS. 5 through 9 are cross-sectional views illustrating various examples of light emitting diode (LED) devices applicable to a monochromatic light source according to an exemplary embodiment in the present inventive concept;

FIG. 10 is a graph illustrating a spectrum distribution illustrating an operation of a light emitting apparatus according to an exemplary embodiment in the present inventive concept; and

FIG. 11 is a flowchart illustrating an operation of a light emitting apparatus according to an exemplary embodiment in the present inventive concept.

### DETAILED DESCRIPTION

Hereinafter, exemplary embodiments in the present inventive concept will be described in detail with reference to the accompanying drawings.

The present inventive concept may, however, be exemplified in many different forms and should not be construed as being limited to the specific embodiments set forth herein. Rather, these embodiments are provided so that this inventive concept will be thorough and complete, and will fully convey the scope of the inventive concept to those skilled in the art.

In the drawings, the shapes and dimensions of elements may be exaggerated for clarity, and the same reference numerals will be used throughout to designate the same or like elements.

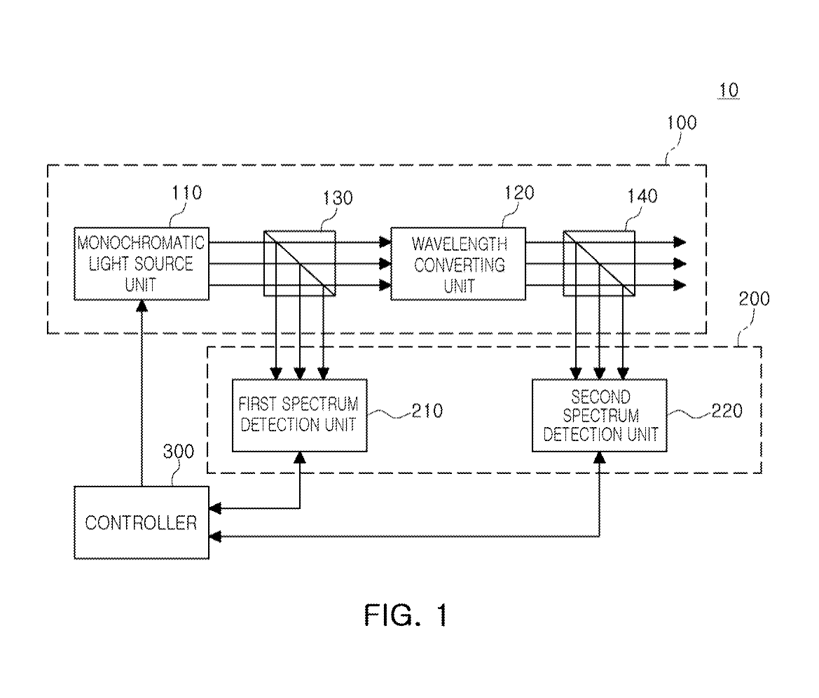

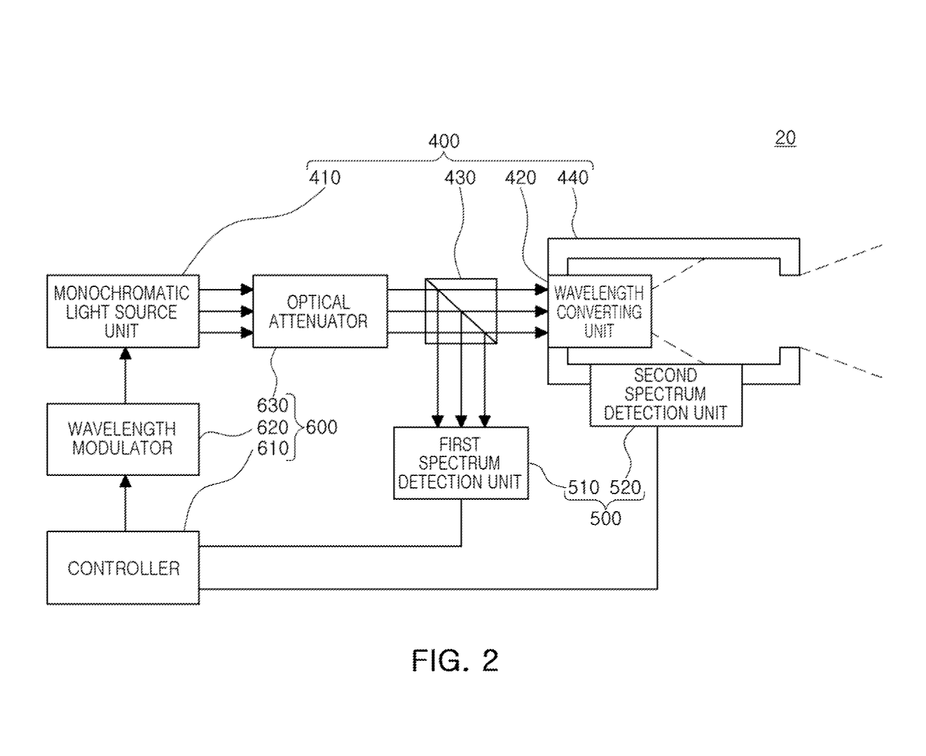

FIGS. 1 and 2 are block diagrams illustrating light emitting apparatuses according to exemplary embodiments in the present inventive concept.

Referring to FIG. 1, a light emitting apparatus 10 according to an exemplary embodiment may include a light emitting unit 100, a spectrum detection unit 200, and a controller 300. The light emitting apparatus 10 illustrated in the exemplary embodiment of FIG. 1 may be an apparatus provided to generate light having a predetermined color, for example, white light.

The light emitting unit 100 may include a monochromatic light source 110 generating light having a predetermined color, a wavelength conversion element 120 receiving the light generated by the monochromatic light source 110 and generating light having a different color, and optical splitters 130 and 140 reflecting a portion of light generated by the monochromatic light source 110 and emitted externally and allowing the portion of light to be incident onto the spectrum detection unit 200. The light emitting unit 100 may include a first optical splitter 130 and a second optical splitter 140. Referring to FIG. 1, the first optical splitter 130 may reflect a portion of light emitted by the monochromatic light source 110, and the second optical splitter 140 may reflect a portion of light having been transmitted through the wavelength conversion element 120.

The spectrum detection unit 200 may include a first spectrum detector 210 and a second spectrum detector 220. The first spectrum detector 210 may detect a first spectrum distribution in light reflected by the first optical splitter 130. The second spectrum detector 220 may detect a second spectrum distribution in light reflected by the second optical splitter 140.

The monochromatic light source 110 may include a laser light source or a light emitting diode (LED) device. In a case in which the monochromatic light source 110 includes a laser light source, the laser light source may be an optical fiber laser capable of adjusting a dominant wavelength of light within a predetermined range thereof. On the other hand, in a case in which the monochromatic light source 110 includes an LED device, the monochromatic light source 110 may include a plurality of LED devices generating light having different dominant wavelengths.

As described above, the light emitting apparatus 10 according to the exemplary embodiment illustrated in FIG. 1 may be an apparatus for generating white light. In order to generate white light, the monochromatic light source 110 may include a light source emitting blue light, and the wavelength conversion element 120 may include a phosphor converting a portion of blue light emitted by the monochromatic light source 110 into light having a color other than blue. In the case that the monochromatic light source 110 includes a light source emitting blue light, the wavelength conversion element 120 may include at least one of a yellow phosphor, a green phosphor, a red phosphor, and an orange phosphor.

The wavelength conversion element 120 including a phosphor may be disposed to be physically separated from the monochromatic light source 110. That is, the wavelength conversion element 120 and the monochromatic light source 110 may not be in direct contact with one another. By disposing the wavelength conversion element 120 to be separate from the monochromatic light source 110, heat generated by a light source included in the monochromatic light source 110 during an operation of the light source transferred to the wavelength conversion element 120 may be minimized, and deterioration of the phosphor caused by such heat may be prevented. Meanwhile, the phosphor included in the wavelength conversion element 120 may have a predetermined level of light conversion efficiency.

The controller 300 may control an operation of the monochromatic light source 110 based on the first and second spectrum distributions detected by the spectrum detection unit 200. For example, the controller 300 may compare the first and second spectrum distributions with predetermined first and second reference spectrum distributions, respectively, and may control the operation of the monochromatic light source 110 based on the comparison result.

As described above, the first spectrum detector 210 may detect the first spectrum distribution in light reflected by the first optical splitter 130, and the first spectrum distribution may correspond to a spectrum distribution of light generated by the monochromatic light source 110. On the other hand, the second spectrum detector 220 may detect the second spectrum distribution in light reflected by the second optical splitter 140, and the second spectrum distribution may correspond to a spectrum distribution of light having been transmitted through the wavelength conversion element 120. For example, in the case in which the light emitting apparatus 10 is an apparatus for generating white light and the monochromatic light source 110 emits blue light, the first spectrum distribution may be a spectrum distribution of the blue light emitted by the monochromatic light source 110, and the second spectrum distribution may be a spectrum distribution of the white light.

In order to generate white light having desired characteristics, the controller 300 may compare the first and second spectrum distributions with the first and second reference spectrum distributions, respectively, and may control the operation of the monochromatic light source 110. Here, the first reference spectrum distribution may be a reference spectrum distribution with respect to light emitted by the monochromatic light source 110, and the second reference spectrum distribution may be a reference spectrum distribution with respect to light finally emitted by the light emitting apparatus 10.

The controller 300 may adjust a wavelength of light emitted by the monochromatic light source 110 based on the result of comparing the first spectrum distribution and the first reference spectrum distribution. For example, in a case in which a dominant wavelength of light emitted by the monochromatic light source 110 needs to be 440 nanometers (nm) in order to obtain desired white light, the dominant wavelength of light emitted by the monochromatic light source 110 may be greater than 440 nm due to an increase in a temperature of the light source included in the monochromatic light source 110 or other external factors. In this case, a dominant wavelength in the first spectrum distribution detected by the first spectrum detector 210 may be detected to be greater than 440 nm. The controller 300 may compare the dominant wavelength detected in the first spectrum distribution with a dominant wavelength represented in the first reference spectrum distribution, and may increase or decrease the dominant wavelength of light emitted by the monochromatic light source 110 based on the comparison result.

On the other hand, the controller 300 may adjust an intensity of light emitted by the monochromatic light source 110 based on the result of comparing the second spectrum distribution and the second reference spectrum distribution. In a case in which the monochromatic light source 110 includes a light source generating blue light in order to generate white light, and the wavelength conversion element 120 includes a yellow phosphor, a portion of the blue light may be converted into yellow light by the yellow phosphor to be output as yellow light. That is, the portion of blue light may be converted into yellow light by the yellow phosphor, and the remainder of blue light may be transmitted through the wavelength conversion element 120 to be output as blue light. Accordingly, yellow light converted by the yellow phosphor of the wavelength conversion element 120 and blue light having been transmitted through the wavelength conversion element 120 may be combined to generate white light.

The second spectrum detector 220 may receive light incident from the second optical splitter 140, and may generate the second spectrum distribution. Accordingly, the second spectrum distribution may be a spectrum distribution of white light finally output from the light emitting apparatus 10. The controller 300 may compare a ratio of yellow light intensity to blue light intensity represented in the second spectrum distribution with a ratio of yellow light intensity to blue light intensity represented in the second reference spectrum distribution. Here, the second reference spectrum distribution may be a spectrum distribution of white light which is preset as a reference.

In a case in which an ratio of blue light intensity to yellow light intensity represented in the second spectrum distribution is determined to be lower than an ratio of blue light intensity to yellow light intensity represented in the second reference spectrum distribution, the controller 300 may increase an intensity of light emitted by the monochromatic light source 110. Conversely, in a case in which the ratio of blue light intensity to yellow light intensity represented in the second spectrum distribution is determined to be higher than the ratio of blue light intensity to yellow light intensity represented in the second reference spectrum distribution, the controller 300 may decrease the intensity of light emitted by the monochromatic light source 110. Through the controlling as described above, the light emitting apparatus 10 may generate and output light having desired characteristics.

Referring to FIG. 2, a light emitting apparatus 20 according to an exemplary embodiment may include a light emitting unit 400, a spectrum detection unit 500, and a controller 600. The light emitting unit 400 may include a monochromatic light source 410, a wavelength conversion 420, an optical splitter 430, and a light guide 440, and the like. The spectrum detection unit 500 may include first and second spectrum detectors 510 and 520, and the controller 600 may adjust an operation of the monochromatic light source 410 through an optical attenuator 610 and a wavelength modulator 620.

The monochromatic light source 410 included in the light emitting unit 400 may include a laser light source, an LED device, or the like, outputting light having a predetermined color in a manner similar to the monochromatic light source 110 illustrated in FIG. 1. When the monochromatic light source 410 includes a laser light source, the laser light source may be an optical fiber laser capable of adjusting a dominant wavelength of light within a predetermined range thereof, and in this case, the wavelength modulator 620 may be omitted. On the other hand, when the monochromatic light source 410 includes an LED device, the monochromatic light source 410 may include a plurality of LED devices emitting light having different dominant wavelengths.

The wavelength conversion element 420 may include a phosphor converting a portion of blue light emitted by the monochromatic light source 410 into light having a color different therefrom. Light having been transmitted through the wavelength conversion element 420 may be emitted externally through the light guide 440. In a case in which the monochromatic light source 410 emits blue light and the wavelength conversion element 420 includes yellow and green phosphors, a portion of the blue light may be converted into yellow light and green light by the yellow and green phosphors, and the blue light, the yellow light, and the green light may be combined within the light guide 440 to be emitted as white light.

The spectrum detection unit 500 may include a first spectrum detector 510 and a second spectrum detector 520. The first spectrum detector 510 may detect a first spectrum distribution in light emitted by the monochromatic light source 410, and the second spectrum detector 520 may detect a second spectrum distribution in light having been transmitted through the wavelength conversion element 420. The second spectrum detector 520 may be installed in the light guide 440.

The controller 600 may adjust an operation of the wavelength modulator 620 adjusting a wavelength of light emitted by the monochromatic light source 410, and an operation of the optical attenuator 610 adjusting an amount of light emitted by the monochromatic light source 410 and incident onto the wavelength conversion element 420.

The wavelength modulator 620 may adjust a wavelength of light emitted by the monochromatic light source 410 through being controlled by the controller 600. In a case in which the monochromatic light source 410 includes a plurality of LED devices emitting light having different dominant wavelengths, the wavelength modulator 620 may select an LED device from among the plurality of LED devices to be turned on, through being controlled by the controller 600. Here, the wavelength modulator 620 may be a circuit configured of one or more switch elements.

The controller 600 may adjust the operations of the wavelength modulator 620 and the optical attenuator 610 based on the result of comparing the first and second spectrum distributions detected by the first and second spectrum detectors 510 and 520 with first and second reference spectrum distributions, respectively. The first spectrum distribution detected by the first spectrum detector 510 may correspond to a spectrum distribution of light emitted by the monochromatic light source 410, and the second spectrum distribution detected by the second spectrum detector 520 may correspond to a spectrum distribution of light having been transmitted through the wavelength conversion element 420 and travelling through the light guide 440.

As a result of comparing the first spectrum distribution with the first reference spectrum distribution, in a case in which a mismatch in dominant wavelengths is discovered between the first spectrum distribution and the first reference spectrum distribution, the controller 600 may adjust, for example, by controlling the wavelength modulator 620, a wavelength of light emitted by the monochromatic light source 410. In a case in which a dominant wavelength represented in the first spectrum distribution is less than a dominant wavelength represented in the first reference spectrum distribution, the controller 600 may increase, for example, by controlling the wavelength modulator 620, a dominant wavelength of light emitted by the monochromatic light source 410 towards a long wavelength.

In addition, the controller 600 may control the operation of the optical attenuator 610 based on the result of comparing an intensity for each wavelength band represented in the second spectrum distribution with an intensity for each wavelength band represented in the second reference spectrum distribution. In a case in which the monochromatic light source 410 emits blue light and the wavelength conversion element 420 includes yellow and green phosphors, the controller 600 may calculate an intensity ratio of blue light to yellow and green light for each of the second spectrum distribution and the second reference spectrum distribution.

As a result of comparing the intensity ratio of blue light to yellow light and green light calculated from the second spectrum distribution with the intensity ratio of blue light to yellow light and green light calculated from the second reference spectrum distribution, when the intensity ratio calculated from the second spectrum distribution is determined to be less than that calculated from the second reference spectrum distribution, the controller 600 may adjust the optical attenuator 610 to increase an amount of light emitted by the monochromatic light source 410 and incident onto the wavelength conversion element 420. Conversely, as the result of comparing the intensity ratio of blue light to yellow light and green light calculated by the second spectrum distribution with the intensity ratio of blue light to yellow light and green light calculated by the second reference spectrum distribution, when the intensity ratio calculated from the second spectrum distribution is determined to be greater than that calculated from the second reference spectrum distribution, the controller 600 may adjust the optical attenuator 610 to reduce the amount of light emitted by the monochromatic light source 410 and incident onto the wavelength conversion element 420. Through the controlling as described above, the light emitting apparatus 20 may generate and output light having desired characteristics.

The controllers 300 and 600 in the light emitting apparatus 10 and 20 illustrated in FIGS. 1 and 2 may determine a presence of errors in the spectrum detection units 200 and 500. Phosphors included in the wavelength conversion elements 120 and 420 may have a predetermined level of light conversion efficiency, and the controllers 300 and 600 may determine errors present in the spectrum detection units 200 and 500 using characteristics of the phosphors having the predetermined level of light conversion efficiency. Conversion efficiency of the phosphor may be determined based on at least one of a dominant wavelength, a full width at half maximum (FWHM), and an intensity of light emitted by the monochromatic light sources 110 and 410.

For example, when blue light having an intensity of 100 is emitted by the monochromatic light sources 110 and 410 and is incident onto the wavelength conversion elements 120 and 420, respectively, a case in which blue light having an intensity of 50 is incident onto a yellow phosphor and is converted into yellow light having an intensity of 40 may be illustrated by way of example. Based on the above example, the light emitting apparatuses 10 and 20 may generate white light in which blue light and yellow light are combined at a ratio of 50 to 40.

Here, the controllers 300 and 600 may be configured to adjust an intensity of blue light emitted by the monochromatic light sources 110 and 410 in order to determine an error which may occur at the time of detecting a spectrum distribution. That is, the controllers 300 and 600 may be configured to adjust an intensity of blue light emitted by the monochromatic light sources 110 and 410, such that the intensity of blue light represented in the second spectrum distribution is the same as an intensity of blue light defined in the second spectrum distribution. When the intensity of blue light represented in the second spectrum distribution is the same as the intensity of blue light defined in the second spectrum distribution, in a case in which a ratio of yellow light intensity to blue light intensity represented in the second spectrum distribution does not match a ratio of yellow light intensity to blue light intensity defined in the second spectrum distribution, the controllers 300 and 600 may determine that errors are present in the spectrum detection units 200 and 500.

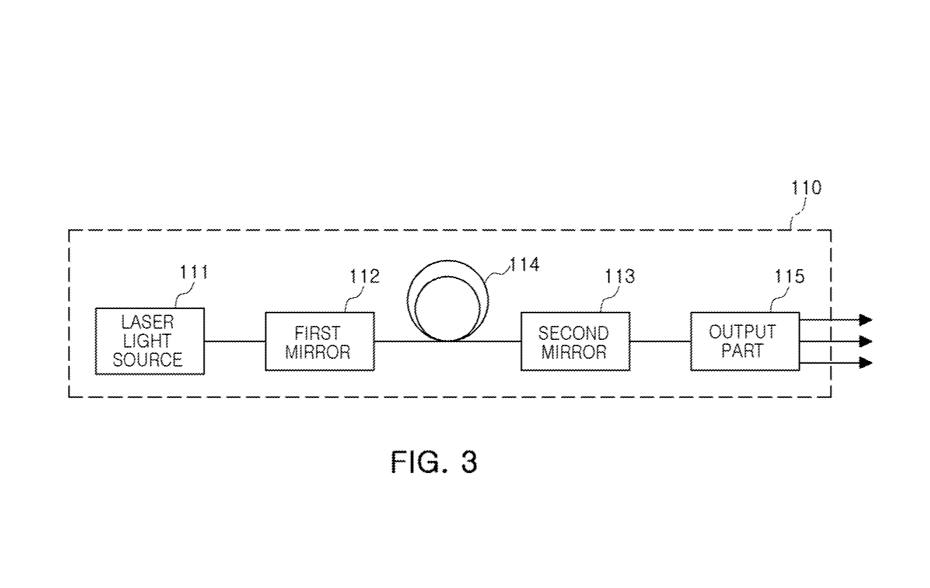

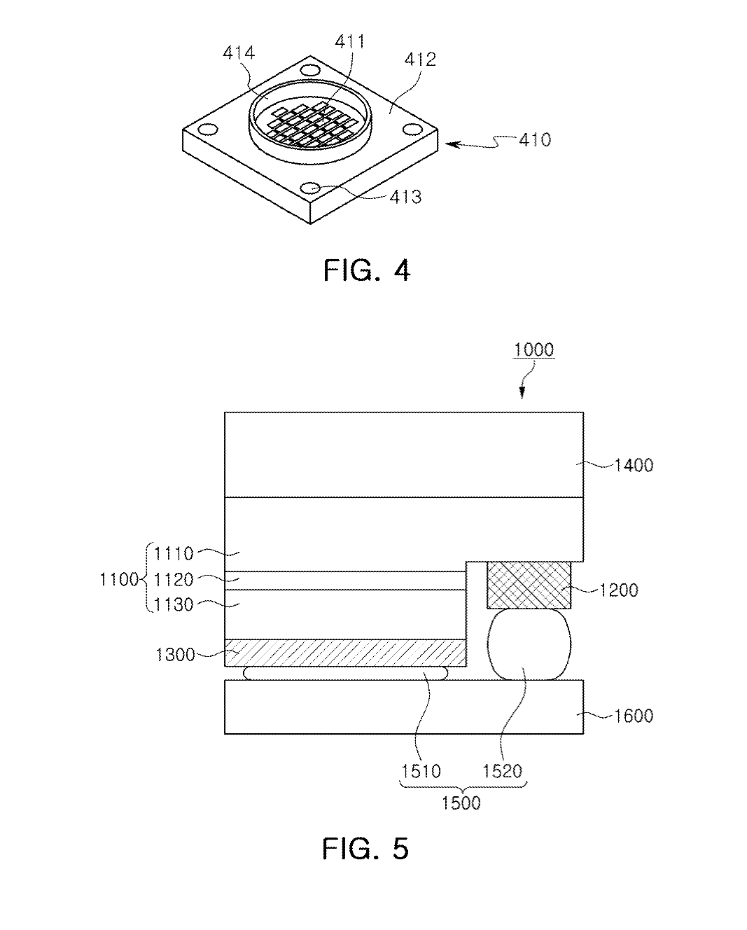

FIGS. 3 and 4 are views illustrating monochromatic light sources applicable to a light emitting apparatus according to an exemplary embodiment in the present inventive concept. FIG. 3 illustrates the monochromatic light source 110 as being applicable to the light emitting apparatus 10 according to the exemplary embodiment illustrated in FIG. 1, while FIG. 4 illustrates the monochromatic light source 410 as being applicable to the light emitting apparatus 20 according to the exemplary embodiment illustrated in FIG. 2; however, the present exemplary embodiment is not limited thereto.

Referring to FIG. 3, the monochromatic light source 110 according to the exemplary embodiment may include an optical fiber laser as a light source. The monochromatic light source 110 may include a laser light source 111 generating light having a predetermined color, an optical fiber 114 transferring the light generated in the laser light source 111, mirrors 112 and 113, and an output part 115. The light generated in the laser light source 111 may be transferred to the output part 115 through total reflection in the optical fiber 114 disposed between the first mirror 112 and the second mirror 113 functioning as a reflector.

An intensity and a wavelength of light emitted by the monochromatic light source 110 may be adjusted by the controller 300 connected to the monochromatic light source 110. A first spectrum distribution detected in the first spectrum detector 210 may correspond to a spectrum distribution of light generated by the laser light source 111, and the controller 300 may compare the first spectrum distribution with a first reference spectrum distribution. The first reference spectrum distribution may be a preset spectrum distribution to be applied as a reference with respect to light emitted by the laser light source 111. In a case in which a dominant wavelength represented in the first spectrum distribution is greater or less than a dominant wavelength represented in the first reference spectrum distribution, the controller 300 may adjust a length of the optical fiber 114, such that a dominant wavelength of light output from the output part 115 may be reduced or increased.

On the other hand, a second spectrum distribution detected by the second spectrum detector 220 may correspond to a spectrum distribution of light having been transmitted through the wavelength conversion element 120. The controller 300 may compare the second spectrum distribution with a second reference spectrum distribution, and the second reference spectrum distribution may be a spectrum distribution of light intended to be output using the light emitting apparatus 10.

The controller 300 may compare a ratio of intensity of light for each predetermined wavelength band represented in the second spectrum distribution with a ratio of intensity of light for each predetermined wavelength band represented in the second reference spectrum distribution. For example, in a case in which the laser light source 111 generates blue light, and a phosphor included in the wavelength conversion element 120 absorbs a portion of the blue light and generates yellow light, the controller 300 may compare an intensity ratio of yellow light and blue light represented in the second spectrum distribution with an intensity ratio of yellow light and blue light represented in the second reference spectrum distribution.

As a result of the comparison, in a case in which a ratio of blue light intensity to yellow light intensity in the second spectrum distribution is greater than a ratio of blue light intensity to yellow light intensity in the second reference spectrum distribution, the controller 300 may lower a level of output of the laser light source 111. Conversely, in a case in which the ratio of blue light intensity to yellow light intensity in the second spectrum distribution is less than the ratio of blue light intensity to yellow light intensity in the second reference spectrum distribution, the controller 300 may increase a level of output of the laser light source 111. Accordingly, the controller 300 may adjust light output from the light emitting apparatus 10 to match the initially set second reference spectrum distribution.

Referring to FIG. 4, the monochromatic light source 410 according to the exemplary embodiment may be provided in a form of an LED package, and may include a substrate 412 and a plurality of LED devices 411 to be mounted on the substrate 412. The LED devices 411 having various structures, such as an epi-up structure, a flip-chip structure, a vertical structure, or the like, may be applied to the monochromatic light source 410. The LED devices 411 to be applicable to the monochromatic light source 410 according to various exemplary embodiments will be described with reference to FIGS. 5 through 9.

The plurality of LED devices 411 may be disposed within a cavity 414 provided in the substrate 412. One or more fixing units 413 for fixing the monochromatic light source 410 to an external module may be provided in the substrate 412.

In the present exemplary embodiment, an operation of the monochromatic light source 410 may be adjusted by the controller 600. The controller 600 may control the operation of the monochromatic light source 410 based on the result of comparing first and second spectrum distributions detected by the first and second spectrum detectors 510 and 520 with first and second reference spectrum distributions, respectively.

The first spectrum distribution may be a spectrum distribution detected from light output from the monochromatic light source 410. The controller 600 may compare the first spectrum distribution with the first reference spectrum distribution, and may determine an LED device 411 to be turned on from among the plurality of LED devices 411 based on a result of the comparison. The plurality of LED devices 411 included in the monochromatic light source 410 may output light having different dominant wavelengths, and the controller 600 may determine an LED device 411 from among the plurality of LED devices 411 to be turned on based on the result of comparing the dominant wavelengths represented in the first spectrum distribution with those represented in the first reference spectrum distribution.

For example, in a case in which a dominant wavelength represented in the first spectrum distribution is 440 nm, and a dominant wavelength represented in the first reference spectrum distribution is 450 nm, the controller 600 may turn on an LED device 411 outputting light having a relatively long wavelength. Accordingly, the dominant wavelength of light emitted by the monochromatic light source 410 and incident onto the wavelength conversion element 420 may be increased. Conversely, in a case in which the dominant wavelength represented in the first spectrum distribution is greater than the dominant wavelength represented in the first reference spectrum distribution, the controller 600 may turn on an LED device 411 outputting light having a relatively short wavelength. That is, the dominant wavelength of light output from the monochromatic light source 410 may be determined based on the result of comparing the first spectrum distribution and the first reference spectrum distribution.

On the other hand, an intensity of light output from the monochromatic light source 410 may be determined based on a result of comparing the second spectrum distribution and the second reference spectrum distribution. The controller 600 may compare an intensity for each wavelength band represented in the second spectrum distribution with an intensity for each wavelength band represented in the second reference spectrum distribution. For example, in a case in which the monochromatic light source 410 includes a plurality of LED devices 411 generating blue light, and the wavelength conversion element 420 includes a yellow phosphor, the controller 600 may calculate a ratio of blue light intensity to yellow light intensity in each of the second spectrum distribution and the second reference spectrum distribution, and may compare the calculated intensity ratios with one another.

In a case in which the ratio of blue light intensity to yellow light intensity in the second spectrum distribution is greater than that in the second reference spectrum distribution, the controller 600 may decrease an intensity output from the monochromatic light source 410. Conversely, in a case in which the ratio of blue light intensity to yellow light intensity in the second spectrum distribution is less than that in the second reference spectrum distribution, the controller 600 may increase the intensity output from the monochromatic light source 410. For example, the controller 600 may increase or decrease the intensity output from the monochromatic light source 410 by adjusting the optical attenuator 610 or adjusting the number of LED devices 411 to be turned on.

Hereinafter, various examples of the LED devices 411 to be included in the monochromatic light source 410 will be described with reference to FIGS. 5 through 9.

FIGS. 5 through 9 are cross-sectional views illustrating various examples of LED devices applicable to a monochromatic light source according to an exemplary embodiment in the present inventive concept.

Referring to FIG. 5, an LED device 1000 according to an exemplary embodiment in the present disclosure may include a light emitting structure 1100 including a first conductivity-type semiconductor layer 1110, an active layer 1120, and a second conductivity-type semiconductor layer 1130, a first electrode 1200 electrically connected to the first conductivity-type semiconductor layer 1110, and a second electrode 1300 electrically connected to the second conductivity-type semiconductor layer 1130. The light emitting structure 1100 may be provided with a support substrate 1400 attached to a surface thereof.

The LED device 1000 according to the exemplary embodiment illustrated in FIG. 5 may have a flip-chip structure in which light is emitted through the support substrate 1400. Accordingly, as illustrated in FIG. 5, the first electrode 1200 and the second electrode 1300 may be attached to a circuit substrate 1600 through a solder bump 1500, or the like. Due to an electrical signal applied to the circuit substrate 1600, electron-hole recombination may occur in the active layer 1120. The circuit substrate 1600 may be a portion of the substrate 412 illustrated in FIG. 4. Light generated by such electron-hole recombination may be transmitted upwardly through the support substrate 1400 having light transmissivity, or may be transmitted upwardly through being reflected by the second electrode 1300. Accordingly, the second electrode 1300 may include a material having relatively high reflectivity.

In the exemplary embodiment, the first conductivity-type semiconductor layer 1110 may be an n-type nitride semiconductor layer, and the second conductivity-type semiconductor layer 1130 may be a p-type nitride semiconductor layer. Due to characteristics of the p-type nitride semiconductor layer, such as having a resistance level higher than that of the n-type nitride semiconductor layer, ohmic contact between the second conductivity-type semiconductor layer 1130 and the second electrode 1300 may be difficult. However, in the exemplary embodiment illustrated in FIG. 5, since an area of the second electrode 1300 is substantially the same as that of the second conductivity-type semiconductor layer 1130, ohmic contact between the second conductivity-type semiconductor layer 1130 and the second electrode 1300 may be secured.

Also, due to characteristics of the LED device 1000 in which light is mainly extracted upwardly from an upper portion of the LED device 1000 to which the substrate support 1400 is attached, output efficiency of the LED device 1000 may be enhanced by forming the second electrode 1300, using a material having relatively high reflectivity. To reflect light generated in the active layer 1120 through electron-hole recombination and externally emit the light through the support substrate 1400, the second electrode 1300 may include a material having relatively high reflectivity, such as silver (Ag), nickel (Ni), aluminum (Al), rhodium (Rh), palladium (Pd), Iridium (Ir), ruthenium (Ru), magnesium (Mg), zinc (Zn), platinum (Pt), or gold (Au).

The first conductivity-type semiconductor layer 1110 and the second conductivity-type semiconductor layer 1130 constituting the light emitting structure 1100 may be the n-type semiconductor layer and the p-type semiconductor layer, respectively, as previously described. For example, the first conductivity-type semiconductor layer 1110 and the second conductivity-type semiconductor layer 1130 may be formed of a Group III nitride semiconductor, for example, a material having a composition of AlₓIn_{y}Ga_{1-x-y}N, wherein 0≦x≦1, 0≦y≦1, 0≦x+y≦1. However, the type of material forming the first conductivity-type semiconductor layer 1110 and the second conductivity-type semiconductor layer 1130 is not limited thereto, and a material such as an aluminum gallium indium phosphide (AlGaInP)-based semiconductor or an aluminum gallium arsenide (AlGaAs)-based semiconductor may also be used.

The first conductivity-type semiconductor layer 1110 and the second conductivity-type semiconductor layer 1130 may have a monolayer structure. Alternatively, the first conductivity-type semiconductor layer 1110 and the second conductivity-type semiconductor layer 1130 may have a multilayer structure having different compositions, thicknesses, and the like, as necessary. For example, the first conductivity-type semiconductor layer 1110 and the second conductivity-type semiconductor layer 1130 may have a carrier injection layer capable of enhancing a level of injection efficiency of electrons and holes, and may further have a superlattice structure in various forms.

The first conductivity-type semiconductor layer 1110 may further include a current spreading layer in an area adjacent to the active layer 1120. The current spreading layer may have a structure in which a plurality of InₓAl_{y}Ga_{(1-x-y)}N layers, 0≦x≦1, 0≦y≦1, 0≦x+y≦1, having different compositions or different impurity contents are iteratively laminated, or may have an insulating layer partially formed therein.

The second conductivity-type semiconductor layer 1130 may further include an electron blocking layer in an area adjacent to the active layer 1120. The electron blocking layer may have a structure in which a plurality of InₓAl_{y}Ga_{(1-x-y)}N layers, wherein 0≦x≦1, 0≦y≦1, 0≦x+y≦1, having different compositions are laminated, or may have one or more layers including Al_{y}Ga_{(1-y)}N, wherein 0≦y≦1. Since the electron blocking layer has a bandgap wider than that of the active layer 1120, transfer of electrons from the active layer 1120 to the second conductivity-type semiconductor layer 1130 may be prevented.

In the exemplary embodiment, the light emitting structure 1100 may be formed by using a metal-organic chemical vapor deposition (MOCVD) apparatus. In order to manufacture the light emitting structure 1100, an organic metal compound gas, for example, trimethyl gallium (TMG) or trimethyl aluminum (TMA), and a nitrogen-containing gas, for example, ammonia (NH₃) may be supplied to a reaction container in which a growth substrate is installed as reactive gases, the growth substrate may be maintained at a relatively high temperature in a range of 900° C. to 1,100° C., and an impurity gas may be supplied as necessary while a gallium nitride (GaN)-based compound semiconductor is being grown, so as to laminate the GaN-based compound semiconductor as an undoped, n-type, or p-type semiconductor. An n-type impurity may include silicon (Si), a well-known n-type impurity. A p-type impurity may include Zn, cadmium (Cd), beryllium (Be), Mg, calcium (Ca), barium (Ba), and the like. Among these, Mg and Zn may be mainly used.

Also, the active layer 1120 disposed between the first and second conductivity-type semiconductor layers 1110 and 1130 may have a multi-quantum well (MQW) structure in which a quantum well layer and a quantum barrier layer are laminated in an alternating manner. In a case in which the active layer 1120 includes a nitride semiconductor, an MQW structure in which GaN/InGaN layers are laminated in an alternating manner may be employed. According to exemplary embodiments, a single quantum well (SQW) structure may also be used.

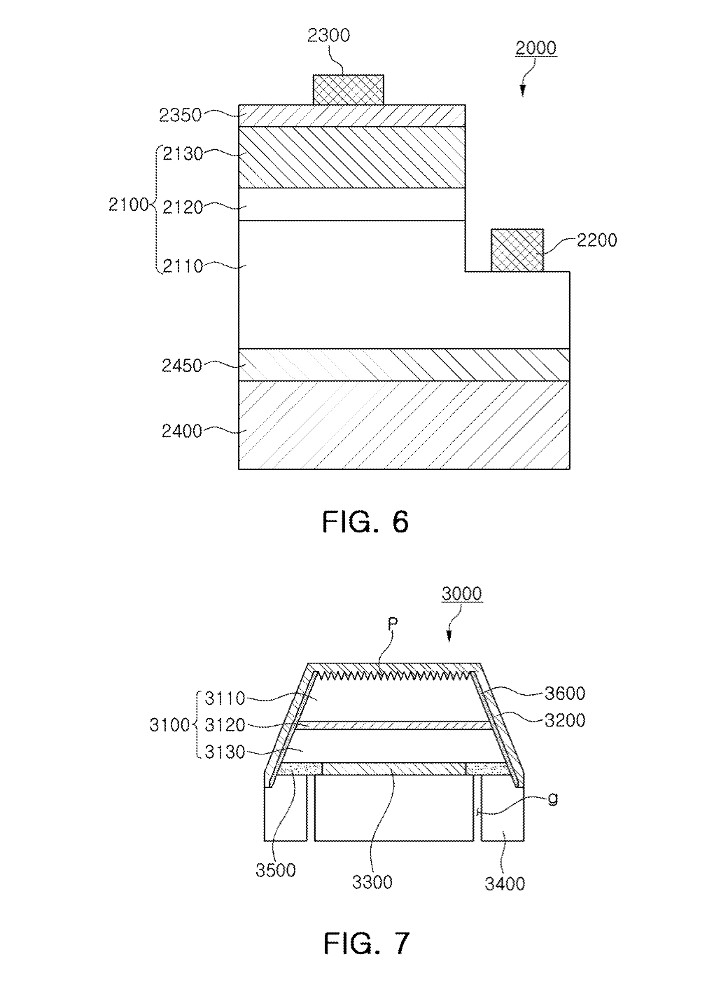

As illustrated in FIG. 6, an LED device 2000 applicable to the monochromatic light source 410 according to the exemplary embodiment in the present disclosure may include a substrate 2400 and a light emitting structure 2100 formed on the substrate 2400. The light emitting structure 2100 may include a first conductivity-type semiconductor layer 2110, an active layer 2120, and a second conductivity-type semiconductor layer 2130.

Also, an ohmic contact layer 2350 may be formed on the second conductivity-type semiconductor layer 2130. First and second electrodes 2200 and 2300 may be formed on top surfaces of the first conductivity-type semiconductor layer 2110 and the ohmic contact layer 2350, respectively.

At least one of an insulating substrate, a conductive substrate, and a semiconductor substrate may be used as the substrate 2400 according to various exemplary embodiments. For example, the substrate 2400 may use a material such as sapphire, silicon carbide (SiC), Si, magnesium aluminate (MgAl₂O₄), magnesium oxide (MgO), lithium aluminate (LiAlO₂), lithium gallium oxide (LiGaO₂), or GaN. For epitaxial growth of a GaN material, a GaN substrate, a homogeneous substrate, may be selected as the substrate 2400. Also, as a heterogeneous substrate, a sapphire substrate, a SiC substrate, or the like, may be selected. In a case of using the heterogeneous substrate, defects such as dislocation may be increased due to a difference between lattice constants of a substrate material and a thin film material. In addition, a difference between thermal expansion coefficients of the substrate material and the thin film material may cause warpage when temperature changes, and such warpage may cause cracks in the thin film. To solve such issues, a buffer layer 2450 may be disposed between the substrate 2400 and the GaN-based light emitting structure 2100.

When the light emitting structure 2100 including GaN is grown on the heterogeneous substrate, dislocation density may be increased due to a lattice constant mismatch between the substrate material and the thin film material, and cracks and warpage may occur due to a difference between the thermal expansion coefficients. To prevent dislocation of and cracks in the light emitting structure 2100, the buffer layer 2450 may be disposed between the substrate 2400 and the light emitting structure 2100. The buffer layer 2450 may adjust a degree of warpage of the substrate while the active layer is grown, to reduce wavelength dispersion of a wafer.

The buffer layer 2450 may use AlₓIn_{y}Ga_{1-x-y}N, wherein 0≦x≦1, 0≦y≦1, more particularly, GaN, aluminum nitride (AlN), aluminum gallium nitride (AlGaN), indium gallium nitride (InGaN), or indium gallium nitride aluminum nitride (InGaNAlN), and as necessary, may use a material, for example, zirconium diboride (ZrB2), hafnium diboride (HfB2), zirconium nitride (ZrN), hafnium nitride (HfN), or titanium nitride (TiN). Further, the buffer layer 2450 may be formed by combining a plurality of layers, or gradually changing a composition thereof.

Thermal expansion coefficients between a Si substrate and GaN are significantly different from one another. In a case in which a GaN-based thin film is grown on a Si substrate, when the GaN-based thin film is grown at a relatively high temperature and cooled to room temperature, cracks may be caused by tensile stress applied to the GaN-based thin film due to the difference in the thermal expansion coefficients between the Si substrate and GaN-based thin film. In order to avoid such cracks, a method of growing the GaN-based thin film that allows compressive stress to be applied to the GaN-based thin film during the growth of the GaN-based thin film may be used to compensate for tensile stress. In addition, due to a difference between lattice constants of Si and GaN, defects may be highly likely to occur. In a case of using the Si substrate, a buffer layer 2450 having a composite structure may be used in order to simultaneously control defects and stress for restraining warpage.

To form the buffer layer 2450, an AlN layer may be initially formed on the substrate 2400. A material not including Ga may be used to avoid a reaction between Si and Ga. Aside from AlN, a material such as SiC may also be used. The AlN layer may be grown at a temperature in a range of 400° C. to 1,300° C. using an Al source and an N source. As necessary, an intermediate AlGaN layer may be interposed between a plurality of AlN layers in order to control stress.

The light emitting structure 2100 may include the first and second conductivity-type semiconductor layers 2110 and 2130, and the active layer 2120. The first and second conductivity-type semiconductor layers 2110 and 2130 may be formed of semiconductors doped with n-type and p-type impurities, respectively. However, the type of the first and second conductivity-type semiconductor layers 2110 and 2130 is not limited thereto. The first and second conductivity-type semiconductor layers 2110 and 2130 may also be formed in a converse manner, for example, the semiconductors doped with p-type and n-type impurities, respectively. For example, the first and second conductivity-type semiconductor layers 2110 and 2130 may be formed of a Group III nitride semiconductor, for example, a material having a composition of AlₓIn_{y}Ga_{1-x-y}N, wherein 0≦x≦1, 0≦y≦1, 0≦x+y≦1. However, the type of material forming the first and second conductivity-type semiconductor layers 2110 and 2130 is not limited thereto, and a material such as an AlGaInP-based semiconductor or an AlGaAs-based semiconductor may also be used.

The first and second conductivity-type semiconductor layers 2110 and 2130 may have a monolayer structure. Alternatively, the first and second conductivity-type semiconductor layers 2110 and 2130 may also have a multilayer structure having different compositions, thicknesses, or the like, as necessary. For example, the first and second conductivity-type semiconductor layers 2110 and 2130 may have a carrier injection layer capable of enhancing a level of injection efficiency of electrons and holes, and may further have a superlattice structure in various forms.

The first conductivity-type semiconductor layer 2110 may further include a current spreading layer in an area adjacent to the active layer 2120. The current spreading layer may have a structure in which a plurality of InₓAl_{y}Ga_{(1-x-y)}N layers, wherein 0≦x≦1, 0≦y≦1, 0≦x+y≦1, having different compositions or different impurity contents are iteratively laminated, or may have an insulating layer partially formed therein.

The second conductivity-type semiconductor layer 2130 may further include an electron blocking layer in an area adjacent to the active layer 2120. The electron blocking layer may have a structure in which a plurality of InₓAl_{y}Ga_{(1-x-y)}N layers, wherein 0≦x≦1, 0≦y≦1, 0≦x+y≦1, having different compositions are laminated, or may have one or more layers including Al_{y}Ga_{(1-y)}N, wherein 0≦y≦1. Since the electron blocking layer has a bandgap wider than that of the active layer 2120, transfer of electrons from the active layer 2120 to the second conductivity-type semiconductor layer 2130 may be prevented.

In the exemplary embodiment, the light emitting structure 2100 may be formed by using an MOCVD apparatus. In order to manufacture the light emitting structure 2100, an organic metal compound gas, for example, TMG or TMA, and a nitrogen-containing gas, for example, NH₃, may be supplied to a reaction container in which a growth substrate is installed as reactive gases, the growth substrate may be maintained at a relatively high temperature in a range of 900° C. to 1,100° C., and an impurity gas may be supplied as necessary while a GaN-based compound semiconductor is being grown, so as to laminate the GaN-based compound semiconductor as an undoped, n-type, or p-type semiconductor. An n-type impurity may include Si, a well-known n-type impurity. A p-type impurity may include Zn, Cd, Be, Mg, Ca, Ba, and the like. Among these, Mg and Zn may be mainly used.

Also, the active layer 2120 disposed between the first and second conductivity-type semiconductor layers 2110 and 2130 may have an MQW structure in which a quantum well layer and a quantum barrier layer are laminated in an alternating manner. For example, in a case in which the active layer 2120 includes a nitride semiconductor, an MQW structure in which GaN/InGaN layers are laminated in an alternating manner may be provided. According to exemplary embodiments, an SQW structure may also be used.

The ohmic-contact layer 2350 may have a relatively high impurity concentration to have relatively low ohmic-contact resistance, thereby lowering an operating voltage of the semiconductor light emitting device and enhancing device characteristics. The ohmic-contact layer 2350 may be formed of a GaN layer, an InGaN layer, a ZnO layer, or a graphene layer. The first or second electrode 2200 and 2300 may include a material such as Ag, Ni, Al, Rh, Pd, Ir, Ru, Mg, Zn, Pt, or Au.

Referring to FIG. 7, an LED device 3000 according to an exemplary embodiment in the present disclosure may include a light emitting structure 3100 and a support structure 3400. The light emitting structure 3100 may include a first conductivity-type semiconductor layer 3110, a second conductivity-type semiconductor layer 3130, and an active layer 3120 disposed therebetween. The light emitting structure 3100 may include a first surface and a second surface provided by the first conductivity-type semiconductor layer 3110 and the second conductivity-type semiconductor layer 3130, respectively, and lateral surfaces disposed therebetween.

The light emitting structure 3100 may include a nitride semiconductor satisfying AlₓIn_{y}Ga_{1-x-y}N, wherein 0≦x≦1, 0≦y≦1, 0≦x+y≦1. The first and second conductivity-type semiconductor layers 3110 and 3130 of the light emitting structure 3100 may be an n-type semiconductor layer and a p-type semiconductor layer, respectively; however, the type of the first and second conductivity-type semiconductor layers 3110 and 3130 is not limited thereto. The first and second conductivity-type semiconductor layers 3110 and 3130 may have a monolayer structure and may alternatively have a multilayer structure having different compositions and/or different doping concentrations of impurities. For example, the first conductivity-type semiconductor layer 3110 may be n-type GaN, and the second conductivity-type semiconductor layers 3130 may be p-type AlGaN/p-type GaN. In the active layer 3120, light having a predetermined wavelength may be generated by recombining electrons and holes supplied from the first and second conductivity-type semiconductor layers 3110 and 3130. For example, the active layer 3120 may have an MQW structure in which a quantum well layer and a quantum barrier layer are laminated in an alternating manner. In a case in which the light emitting structure 3100 is a nitride semiconductor, the active layer 3120 may have an MQW structure in which GaN/InGaN layers are laminated in an alternating manner. However, the structure of the active layer 3120 is not limited thereto, and a SQW structure may also be used as necessary. According to exemplary embodiments, the light emitting structure 3100 may use a semiconductor material having different compositions. For example, aside from the nitride semiconductor, an AlInGaP-based semiconductor or an AlInGaAs-based semiconductor may be used.

The light emitting structure 3100 may be grown on a separate growth substrate, and then may be attached to the support structure 3400. The growth substrate may be removed from the light emitting structure 3100, and an unevenness structure P may be formed on a surface, for example, the first surface provided by the first conductivity-type semiconductor layer 3110, from which the growth substrate is removed, in order to enhance a level of light extraction efficiency. Such an unevenness structure P may be obtained by undertaking wet etching or dry etching using plasma on the first conductivity-type semiconductor layer 3110, subsequently to the growth substrate being removed from the light emitting structure 3100 or during the removing process.

Lateral insulating layers 3600 may be formed on the lateral surfaces of the light emitting structure 3100. As illustrated in FIG. 7, the lateral insulating layers 3600 may be disposed on the entirety of the lateral surfaces of the light emitting structure 3100, and may be provided as passivation layers. The lateral insulating layer 3600 may be a silicon oxide or a silicon nitride. Deposition of the lateral insulating layer 3600 may be facilitated by forming the lateral surface of the light emitting structure 3100 in an inclined manner.

According to the present exemplary embodiment, a first electrode 3200 and a second electrode 3300 may be connected to the first conductivity-type semiconductor layer 3110 and the second conductivity-type semiconductor layer 3130, respectively, through the first surface and the second surface of the light emitting structure 3100, respectively. As illustrated in FIG. 7, since respective connection positions of the first and second electrodes 3200 and 3300 are disposed in a vertical manner, relatively uniform current spreading may be achieved in the light emitting structure 3100, in particular, in the entirety of the active layer.

The first electrode 3200 may include a transparent electrode. The first electrode 3200 may be entirely formed of a transparent electrode, or a connected area of the first surface of the light emitting structure 3100 may be formed of a transparent electrode, and another area of the first surface may be formed of a metal electrode, as necessary.

The first electrode 3200 having characteristics as a transparent electrode may include at least one material selected from the group consisting of indium in oxide (ITO), zinc-doped indium tin oxide (ZITO), zinc indium oxide (ZIO), gallium Indium oxide (GIO), zinc tin oxide (ZTO), fluorine-doped tin oxide (FTO), aluminum-doped zinc oxide (AZO), gallium-doped zinc oxide (GZO), In₄Sn₃O₁₂, or zinc magnesium oxide (Zn₍₁₋ₓ₎MgₓO), wherein 0≦x≦1. As necessary, the first electrode 3200 may include graphene.

The second electrode 3300 may be formed on the second surface of the light emitting structure 3100. For example, the second electrode 3300 may include a material such as Ag, Ni, Al, Rh, Pd, Ir, Ru, Mg, Zn, Pt, or Au. The form of the first electrode 3200 and the second electrode 3300 is not limited to the example illustrated in FIG. 7, and may be modified in various manners. For example, although FIG. 7 depicts the first electrode 3200 as extending along the entirety of both of the lateral surfaces of the light emitting structure 3100, the first electrode 3200 may extend from one of the lateral surfaces.

The support structure 3400 may be disposed on the second surface of the light emitting structure 3100. The support structure 3400 may be divided by an air gap g to form a plurality of package electrodes. In this case, each of the plurality of package electrodes may be bonded to the light emitting structure 3100 by an insulating film 3500 formed on the second surface of the light emitting structure 3100. The insulating film 3500 may be a material capable of bonding, for example, a silicon oxide or a silicon nitride or a resin such as polymer.

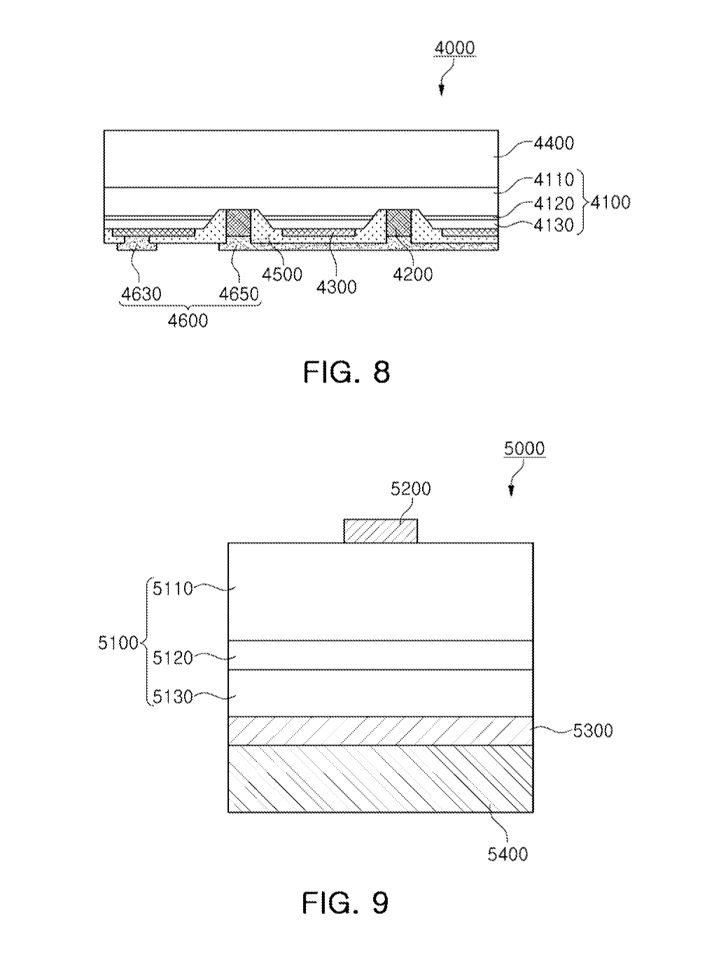

Referring to FIG. 8, an LED device 4000 according to another exemplary embodiment is illustrated. The LED device 4000 may include a light emitting structure 4100 disposed on a surface of a substrate 4400, and first and second electrodes 4200 and 4300 disposed opposite to the substrate 4400 based on the light emitting structure 4100. Also, the LED device 4000 may include an insulating part 4500 formed to cover the first and second electrodes 4200 and 4300. The first and second electrodes 4200 and 4300 may be electrically connected to a connection electrode 4600 having first and second connection electrodes 4630 and 4650.

The light emitting structure 4100 may include a first conductivity-type semiconductor layer 4110, an active layer 4120, and a second conductivity-type semiconductor layer 4130. The first electrode 4200 may be provided as a conductive via penetrating through the second conductivity-type semiconductor layer 4130 and the active layer 4120 to be connected to the first conductivity-type semiconductor layer 4110. The second electrode 4300 may be connected to the second conductivity-type semiconductor layer 4130. The conductive via may include a plurality of conductive vias formed in a single LED device.

A conductive ohmic material may be deposited on the light emitting structure 4100 to form the first and second electrodes 4200 and 4300. The first and second electrodes 4200 and 4300 may include at least one of Ag, Al, Ni, Cr, Cu, Au, Pd, Pt, Sn, Ti, W, Rh, Ir, Ru, Mg, Zn, and an alloy thereof. Also, the second electrode 4300 may serve as a reflective layer reflecting light generated in the active layer 4120.

The insulating part 4500 may be provided with an open area exposing at least portions of the first and second electrodes 4200 and 4300, and the first and second connection electrodes 4630 and 4650 may be connected to the first electrode 4200 and the second electrode 4300, respectively. The insulating part 4500 may be deposited to have a thickness in a range of 0.01 micrometers (μm) to 3 μm at a temperature equal to or lower than 500° C. through a chemical vapor deposition (CVD) process using SiO₂ and/or SiN. The first and second electrodes 4200 and 4300 may be disposed in a single direction, and may be mounted on a lead frame, or the like, in a so-called flip chip manner.

In particular, the first electrode 4200 may be provided as the conductive via penetrating through the second conductivity-type semiconductor layer 4130 and the active layer 4120 to be connected to the first conductivity-type semiconductor layer 4110 within the light emitting structure 4100, and may be connected to the first connection electrode 4630. Here, such as a number, a form, a pitch, and a contact area with the first conductivity-type semiconductor layer 4110 of the conductive via and the first connection electrode 4630 may be appropriately adjusted in order to lower contact resistance between the conductive via and the first connection electrode 4630. The conductive via and the first connection electrode 4630 may be disposed in an array of rows and columns in order to improve current flow.

The second electrode 4300 may be connected to the second connection electrode 4650. In addition to having a function of forming an electrical-ohmic connection with the second conductivity-type semiconductor layer 4130, the second electrode 4300 may be formed of a light reflective material, whereby, in a case in which the LED device 4000 is mounted in a flip chip manner, light emitted by the active layer 4120 may be effectively emitted in a direction of the substrate 4400.

The first and second electrodes 4200 and 4300 may be electrically isolated from one another by the insulating part 4500. The insulating part 4500 may be formed of any material having electrically insulating characteristics. However, a material having a relatively low light absorption rate may be used to form the insulating part 4500. For example, a silicon oxide or a silicon nitride such as SiO₂, SiOₓN_{y}, SiₓN_{y} may be used. As necessary, a light reflective filler may be dispersed within a light transmissive material to form a light reflective structure.

The substrate 4400 may have first and second surfaces opposing one another, and an unevenness structure may be formed on at least one of the first and second surfaces. The unevenness structure formed on one surface of the substrate 4400 may be formed by etching a portion of the substrate 4400 so as to be formed of the same material as that of the substrate 4400. Alternatively, the unevenness structure may be formed of a heterogeneous material different from the material of the substrate 4400. As described hereinbefore, by forming the unevenness structure on an interface between the substrate 4400 and the first conductivity-type semiconductor layer 4110, paths of light emitted by the active layer 4120 may be diverse. Accordingly, a light absorption rate within a semiconductor layer may be reduced and a light scattering rate may be increased, and thus a level of light extraction efficiency may be enhanced. In addition, a buffer layer may be provided between the substrate 4400 and the first conductivity-type semiconductor layer 4110.

Referring to FIG. 9, An LED device 5000 according to an exemplary embodiment is illustrated. The LED device 5000 illustrated in FIG. 9 may include a light emitting structure 5100 including a first conductivity-type semiconductor layer 5110, an active layer 5120, and a second conductivity-type semiconductor layer 5130, a first electrode 5200 attached to the first conductivity-type semiconductor layer 5110, and a second electrode 5300 attached to the second conductivity-type semiconductor layer 5130. A conductive substrate 5400 may be disposed on a lower surface of the second electrode 5300. The conductive substrate 5400 may be mounted directly on a circuit substrate, and the like, constituting a light emitting device package. For example, the conductive substrate 5400 may be mounted on the substrate 412 illustrated in FIG. 4.

In a manner similar to those of the LED devices 1000, 2000, 3000, and 4000 described hereinbefore, the first conductivity-type semiconductor layer 5110 may include an n-type nitride semiconductor, and the second conductivity-type semiconductor layer 5130 may include a p-type nitride semiconductor. The active layer 5120 disposed between the first conductivity-type semiconductor layer 5110 and the second conductivity-type semiconductor layer 5130 may have an MQW structure in which nitride semiconductor layers having different compositions are laminated in an alternating manner. Optionally, the active layer 5120 may also have an SQW structure.

The first electrode 5200 may be disposed on a top surface of the first conductivity-type semiconductor layer 5110, and the second electrode 5300 may be disposed on a lower surface of the second conductivity-type semiconductor layer 5130. Light generated through electron-hole recombination in the active layer 5120 of the LED device 5000 illustrated in FIG. 9 may be emitted through the top surface of the first conductivity-type semiconductor layer 5110. Accordingly, the second electrode 5300 may include a material having relatively high reflectivity in order to allow the light generated in the active layer 5120 to be reflected in a direction of the top surface of the first conductivity-type semiconductor layer 5110.

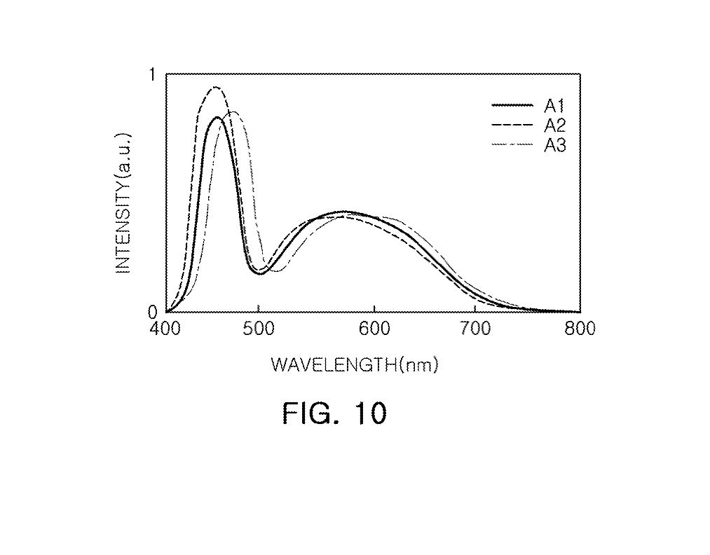

FIG. 10 is a graph illustrating spectrum distribution illustrating an operation of a light emitting apparatus according to an exemplary embodiment in the present disclosure. The spectrum distribution illustrated in FIG. 10 may include a second reference spectrum distribution A1 and second spectrum distributions A2 and A3 detected in different conditions. Hereinafter, for ease of description, by way of example, it may be illustrated that the second spectrum detection unit 220 of the light emitting apparatus 10 illustrated in FIG. 1 detects the second spectrum distribution A2, and the second spectrum detection unit 520 of the light emitting apparatus 20 illustrated in FIG. 2 detects the second spectrum distribution A3.

In an operation of the light emitting apparatus 10 illustrated in FIG. 1, the controller 300 may compare the second spectrum distribution A2 with the second reference spectrum distribution A1. Referring to FIG. 10, the controller 300 may compare the second spectrum distribution A2 with the second reference spectrum distribution A1, and may determine that an intensity is detected to be relatively high in a relatively short wavelength band in the second spectrum distribution A2, and an intensity is detected to be relatively low in a relatively long wavelength band in the second spectrum distribution A2.

That is, the controller 300 may determine that light output from the light emitting apparatus 10 has an intensity excessively high in the relatively short wavelength band. Accordingly, the controller 300 may reduce an intensity output from the monochromatic light source part 110, and may reduce a difference between the second spectrum distribution A2 and the second reference spectrum distribution A1.

In an operation of the light emitting apparatus 20 illustrated in FIG. 2, the controller 600 may compare the second spectrum distribution A3 with the second reference spectrum distribution A1. Referring to FIG. 10, an intensity for each wavelength band in the second spectrum distribution A3 may be similar to an intensity for each wavelength band in the second reference spectrum distribution A1, and an intensity in a relatively long wavelength band in the second spectrum distribution A3 may be higher than an intensity in a relatively long wavelength band in the second reference spectrum distribution A1.

That is, the controller 600 may determine that light output from the light emitting apparatus 20 has a wavelength longer than that set in the second reference spectrum distribution A1. Accordingly, the controller 600 may reduce a dominant wavelength of light output from the monochromatic light source 410, and may reduce a difference between the second spectrum distribution A3 and the second reference spectrum distribution A1.

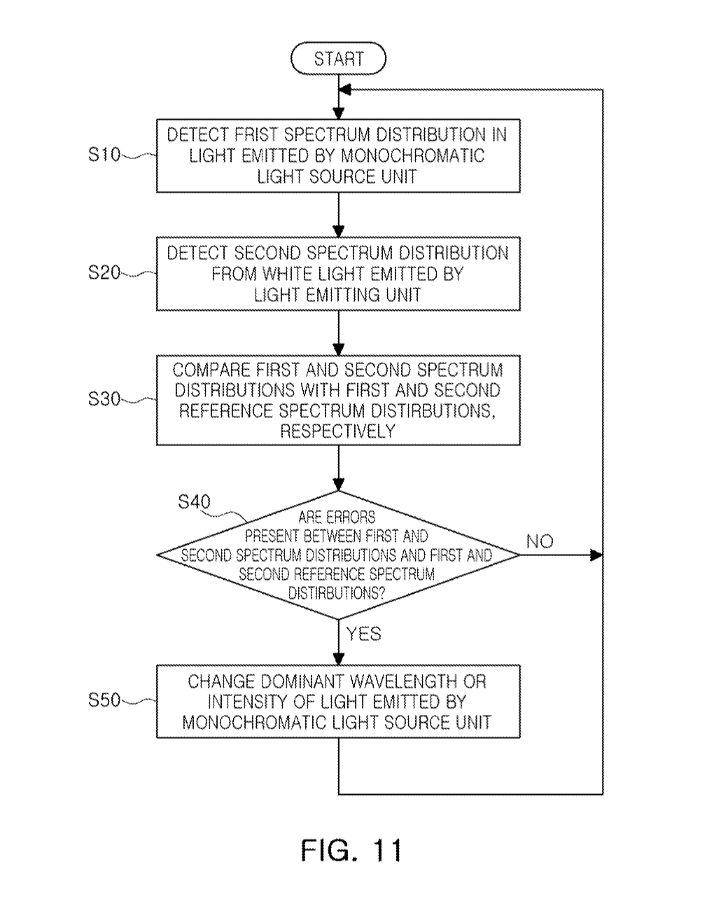

FIG. 11 is a flowchart illustrating an operation of a light emitting apparatus according to an exemplary embodiment in the present disclosure.

Referring to FIG. 11, in operation S10, operations of the light emitting apparatuses 10 and 20 according to the present exemplary embodiment may detect first spectrum distributions from light emitted by the monochromatic light sources 110 and 410, respectively. The first spectrum distributions may be detected by the first spectrum detectors 210 and 510 receiving light incident from the optical splitters 130 and 430 disposed between the monochromatic light sources 110 and 410 and the wavelength conversion elements 120 and 420, respectively.

In operation S20, the second spectrum detectors 220 and 520 may detect second spectrum distributions from white light emitted by the monochromatic light sources 110 and 410, respectively. In operation S30, the controllers 300 and 600 may obtain the first and second spectrum distributions detected in operations S10 and S20, and may compare the first and second spectrum distributions with first and second reference spectrum distributions, respectively.

As a result of the comparison in operation S30, in a case in which differences (or errors) between the first and second reference spectrum distributions and the first and second reference spectrum distributions, respectively, are determined to be present in operation S40, the controllers 300 and 600 may change a dominant wavelength or an intensity output from the monochromatic light sources 110 and 410 in operation S50. Referring to FIG. 10, as illustrated in the graphs A1 and A2, when the second spectrum distribution A2 has a relatively high intensity in a relatively short wavelength, as compared to the second reference spectrum distribution A1, the controllers 300 and 600 may lower levels of output of light emitted by the monochromatic light sources 110 and 410. In addition, as illustrated in the graphs A1 and A3, when the second spectrum distribution A3 has a relatively high intensity in a relatively long wavelength overall, as compared to the second reference spectrum distribution A1, the controllers 300 and 600 may reduce dominant wavelengths of light emitted by the monochromatic light sources 110 and 410.

As set forth above, according to exemplary embodiments in the present inventive concept, in the light emitting apparatus outputting white light, the wavelength conversion element and the monochromatic light source are separately disposed in order to prevent degradation of the phosphor included in the wavelength conversion element. In addition, white light having desired characteristics may be stably output by adjusting a wavelength and an intensity output from the monochromatic light source, using the result of comparing the spectrum distribution detected by the spectrum detection unit and the reference spectrum distribution.

Various advantages and effects in exemplary embodiments in the present inventive concept are not limited to the above-described descriptions and may be easily understood through explanations of concrete embodiments in the present inventive concept.

While exemplary embodiments have been shown and described above, it will be apparent to those skilled in the art that modifications and variations could be made without departing from the scope of the present inventive concept as defined by the appended claims.

What is claimed is:

1. A light emitting apparatus, comprising:
a light emitting unit including a monochromatic light source configured to emit light having a predetermined color, and a wavelength conversion element configured to generate white light from the light emitted by the monochromatic light source;
a spectrum detection unit configured to detect a first spectrum distribution from the light emitted by the monochromatic light source, and detect a second spectrum distribution from the white light; and
a controller configured to compare the first spectrum distribution and the second spectrum distribution with a first reference spectrum distribution and a second reference spectrum distribution, respectively, and adjust at least one of a wavelength and an intensity of the light emitted by the monochromatic light source.

2. The light emitting apparatus of claim 1, wherein the controller adjusts the wavelength of the light emitted by the monochromatic light source by increasing or decreasing a dominant wavelength of the light emitted by the monochromatic light source, based on a result of comparing the first spectrum distribution with the first reference spectrum distribution.

3. The light emitting apparatus of claim 1, wherein the controller increases or decreases an intensity of the light emitted by the monochromatic light source based on a result of comparing the second spectrum distribution with the second reference spectrum distribution.

4. The light emitting apparatus of claim 1, wherein the wavelength conversion element includes a phosphor absorbing a portion of the light emitted by the monochromatic light source and generating light having a different color from the light emitted by the monochromatic light source.

5. The light emitting apparatus of claim 4, wherein the controller calculates an intensity ratio of light in a first wavelength band corresponding to a dominant wavelength of the light emitted by the monochromatic light source to light in a second wavelength band corresponding to a dominant wavelength of light generated by the phosphor from each of the second spectrum distribution and the second reference spectrum distribution.

6. The light emitting apparatus of claim 5, wherein the controller adjusts an intensity of the light emitted by the monochromatic light source based on a result of comparing the intensity ratio calculated from the second spectrum distribution with the intensity ratio calculated from the second reference spectrum distribution.

7. The light emitting apparatus of claim 4, wherein conversion efficiency of the phosphor is determined based on at least one of a dominant wavelength, a full width at half maximum (FWHM), and an intensity of the light emitted by the monochromatic light source.

8. The light emitting apparatus of claim 1, wherein the wavelength conversion element is disposed to be separate from the monochromatic light source.

9. The light emitting apparatus of claim 8, wherein the light emitting unit further includes an optical attenuator and an optical splitter disposed on a path by which the light emitted by the monochromatic light source is transferred to the wavelength conversion element.

10. The light emitting apparatus of claim 9, wherein the controller controls an operation of the optical attenuator based on a result of comparing the second spectrum distribution with the second reference spectrum distribution.

11. The light emitting apparatus of claim 9, wherein the spectrum detection unit includes a first spectrum detector receiving the light emitted by the monochromatic light source through the optical splitter and detecting the first spectrum distribution, and a second spectrum detector receiving the white light generated by the wavelength conversion element and detecting the second spectrum distribution.

12. The light emitting apparatus of claim 1, wherein the monochromatic light source includes at least one laser light source capable of adjusting a wavelength of light to be output.

13. The light emitting apparatus of claim 1, wherein the monochromatic light source includes a plurality of light emitting diode (LED) devices, emitting light having different dominant wavelengths.

14. The light emitting apparatus of claim 13, wherein the controller determines an LED device from among the plurality of LED devices to be turned on, based on a result of comparing the first spectrum distribution with the first reference spectrum distribution.

15. A light emitting apparatus, comprising:
a monochromatic light source configured to emit light having a predetermined dominant wavelength;
a wavelength conversion element including a phosphor having light conversion efficiency determined by characteristics of the light emitted by the monochromatic light source, and configured to generate white light from the light emitted by the monochromatic light source;
a spectrum detection unit configured to detect spectrum distributions of the white light emitted by the wavelength conversion element; and
a controller configured to compare the detected spectrum distribution with a predetermined reference spectrum distribution and adjust an operation of the monochromatic light source,
wherein when an intensity in a wavelength band emitted by the monochromatic light source in the detected spectrum distribution is the same as an intensity in a wavelength band emitted by the monochromatic light source in the reference spectrum distribution, the controller compares an intensity in a wavelength band converted by the phosphor in the detected spectrum distribution with an intensity in a wavelength band converted by the phosphor in the reference spectrum distribution, and determines a presence of an error in the spectrum detection unit.

16. A light emitting apparatus, comprising:
a light emitting unit including a monochromatic light source emitting light having a predetermined color;
a wavelength conversion element converting the light emitted by the monochromatic light source to light having a different color from the predetermined color;
a first spectrum detector receiving the light emitted by the monochromatic light source through an optical splitter interposed on a path by which the light emitted by the monochromatic light source is transferred to the wavelength conversion element, and detecting a first spectrum distribution; and
a controller configured to adjust a wavelength of the light emitted by the monochromatic light source, based on a result of comparing the first spectrum distribution with a first reference spectrum distribution.

17. The light emitting apparatus of claim 16, wherein the controller adjusts the wavelength of light emitted by the monochromatic light source by increasing or decreasing a dominant wavelength of the light emitted by the monochromatic light source.

18. The light emitting apparatus of claim 16, further comprising a second spectrum detector receiving the converted light and detecting a second spectrum distribution from the converted light,
wherein the controller adjusts an intensity of light emitted by the monochromatic light source and incident onto the wavelength conversion element, based on a result of comparing the second spectrum distribution with a second reference spectrum distribution.

19. The light emitting apparatus of claim 16, wherein the converted light is white light.

20. The light emitting apparatus of claim 16, the wavelength conversion element and the monochromatic light source are not in direct contact with one another.
